(19) United States
(12) Patent Application Publication
(10) Pub. No.: US 2013/0212080 A1
(43) Pub. Date: Aug. 15, 2013

(54) IN-CONTEXT DISPLAY OF PRESENTATION SEARCH RESULTS

(71) Applicants: Lawrence D. Bergman, Mount Kisco, NY (US); Ravindranath Konuru, Tarrytown, NY (US); Jie Lu, Hawthorne, NY (US); Moushumi Sharmin, Champaign, IL (US)

(72) Inventors: Lawrence D. Bergman, Mount Kisco, NY (US); Ravindranath Konuru, Tarrytown, NY (US); Jie Lu, Hawthorne, NY (US); Moushumi Sharmin, Champaign, IL (US)

(73) Assignee: INTERNATIONAL BUSINESS MACHINES CORPORATION, Armonk, NY (US)

(21) Appl. No.: 13/370,868

(22) Filed: Feb. 10, 2012

(51) Int. Cl. G06F 17/30

(52) U.S. Cl. 707/706; 707/722; 707/E17.019; 707/E17.108

(57) ABSTRACT

Displays are generated on screens of computer interfaces that facilitate viewing search results in context. Each image returned as a search result is visually presented to a user with additional context images from the same digital media object from which the search result image is taken. If the media object is a slide presentation, the additional context images can include immediately preceding and succeeding slides or other slides in the presentation.

### BACKGROUND

### Field of the Invention

The present invention relates to the layout of multiple images obtained in a search of multimedia objects on a display/interface.

Search engines and search tools provide limited support for search with respect to presentation materials that may comprise a large number of slides. Search requests, also known as queries, are typically formulated as sets of keywords with search results being an entire presentation or, in some systems, single presentation slides. These query responses can be difficult to employ efficiently. When entire presentations are returned, the user must search through the presentation for desired material. If single slides are returned, the user may lack context to aid in determining whether they are actually the material that is desired. This is particularly true when a user is searching his/her own material via, for example, a desktop search. Similar difficulties are applicable to video productions and other visual media.

### BRIEF SUMMARY

Principles of the invention provide a system and techniques for displaying relevant images obtained from a search of a digital object collection in the context of additional images from the same media objects from which the relevant images were obtained. In one aspect, an exemplary method includes the step of searching a digital object collection comprising a plurality of digital objects having sequences of images, thereby obtaining a plurality of search result images from the sequences of images in the plurality of digital objects. The search result images obtained from the digital objects are displayed on a screen of a computer interface in order of relevance. Local context images in association, respectively, with the search result images are displayed, wherein each local context image is obtained from the same digital object as the search result image with which it is associated. The search result images may be advantageously displayed in vertical alignment on the screen of the computer interface while displaying the local context images in horizontal alignment with respect to the search result images with which they are associated.

In accordance with a further aspect of the invention, a system is provided that comprises a memory, a digital object collection comprising a plurality of digital objects having sequences of images, a search engine, a computer interface including a screen, at least one processor, coupled to the computer interface and memory, and operative to: 1) cause the search engine to search the digital object collection in response to a query; 2) obtain a plurality of search result images from the sequences of images in the plurality of digital objects; 3) display the search result images obtained from the digital objects on the screen of the computer interface in order of relevance; and 4) display local context images in association, respectively, with the search result images, wherein each local context image is obtained from the same digital object as the search result image with which it is associated.

In accordance with another aspect, a further exemplary method includes accumulating search result images based on a query from a database comprising digital objects having sequences of images, accumulating local context images associated, respectively, with the search result images from the digital objects; forming a plurality of local context sets, each of the local context sets comprising one of the search result images and one or more associated local context images from a same one of the digital objects; forming a plurality of containers on a display of a computer interface; causing the search result images to be visually distinguished from the local context images; and displaying the local context sets within the containers on the computer interface in an order based on relevance to the query.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable recordable storage medium (or multiple such media).

Techniques of the present invention can provide substantial beneficial technical effects. For example, one or more embodiments may provide one or more of the following advantages:
Presenting slides or other media objects in context rather than in isolation;
Facilitating access to relevant parts of presentations or other visual media;
Facilitating simultaneous comparison between multiple search results and between sets of associated context

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary arrangement of sets of search results on a computer display;

FIG. 2 shows an exemplary display including a plurality of horizontal bars, each bar containing information pertaining to a single search result;

FIG. 3 is a flow chart illustrating steps performed in accordance with an exemplary method, and

FIG. 4 depicts a computer system that may be useful in implementing one or more aspects and/or elements of the invention.

### DETAILED DESCRIPTION

A method and system as described herein provide local context for a set of visual media objects returned from a search of a collection of digital objects. Searches of such collections may be specified via keywords, by providing a single image, a set of images, or an entire media object as the query. Those skilled in the art are familiar with searching using such approaches as well as other types of query specifications that may be employed to obtain desired results. Sets of search results, including search recommendations, are arranged vertically on a screen of a computer display/interface in accordance with an exemplary embodiment discussed below. For each search result, local context is shown, arranged horizontally. Each image returned as a search result is visually presented to the user accompanied by a set of additional images from the same media object. A media object can be, for example, a presentation created using presentation software, a video, and/or an audio work that is stored in a memory and accessible via user query. The additional images provide contextual cues, facilitating a user's recall and recognition of a work stored in a digital memory. If desired, the horizontal dimension may instead be used to arrange search results and the vertical dimension to arrange local context.

Digital media object collections such as slide presentations are useful for educational and business purposes. Such presentations often include charts, graphics, text and pictorial information that are formatted as slides. Commercially available presentation software, such as IBM Lotus Symphony Presentations, allows users to create slide shows from a computer interface. Presentation software is available from a variety of vendors and is in widespread use today. Documents created using such presentation software can be stored electronically for subsequent access by the author or other persons. Depending on formatting and storage location, presentations can be accessible from corporate databases, local area networks, the World Wide Web, and other sources. The method and system provided herein facilitate extracting desired information from presentations and other digitally stored works comprised of a sequence of images by allowing the user to view selected images in the context of other images from the same work.

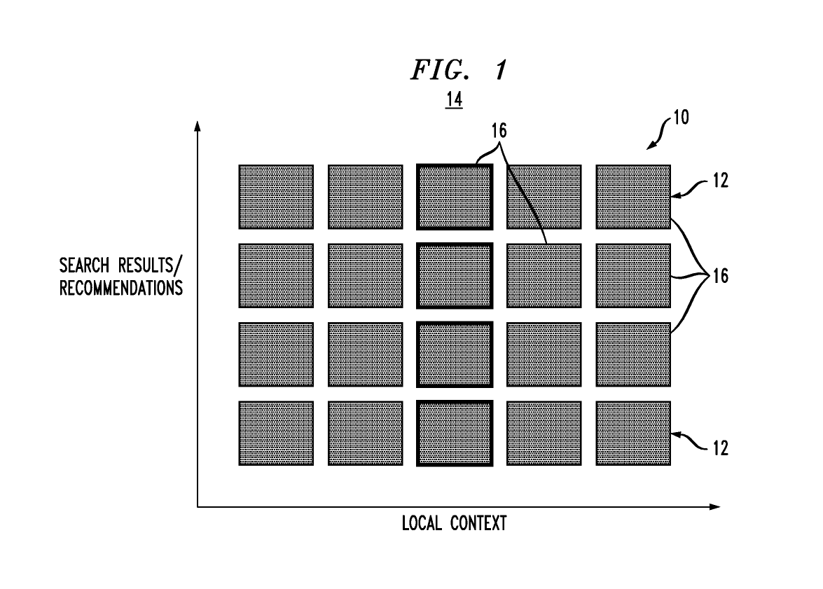

Referring to FIG. 1, a computer display 10 including sets 12 of search results are arranged vertically on the screen 14. For each search result, local context is shown. One of the images 16 in each set 12, the center image in this exemplary embodiment, comprises the search result while the other images in each set provide context. By displaying the sets in such a manner, simultaneous viewing of multiple search results is facilitated. While the embodiment of FIG. 1 shows four sets of search results on the screen, it will be appreciated that a different number of search results can be obtained or displayed using the methods disclosed herein.

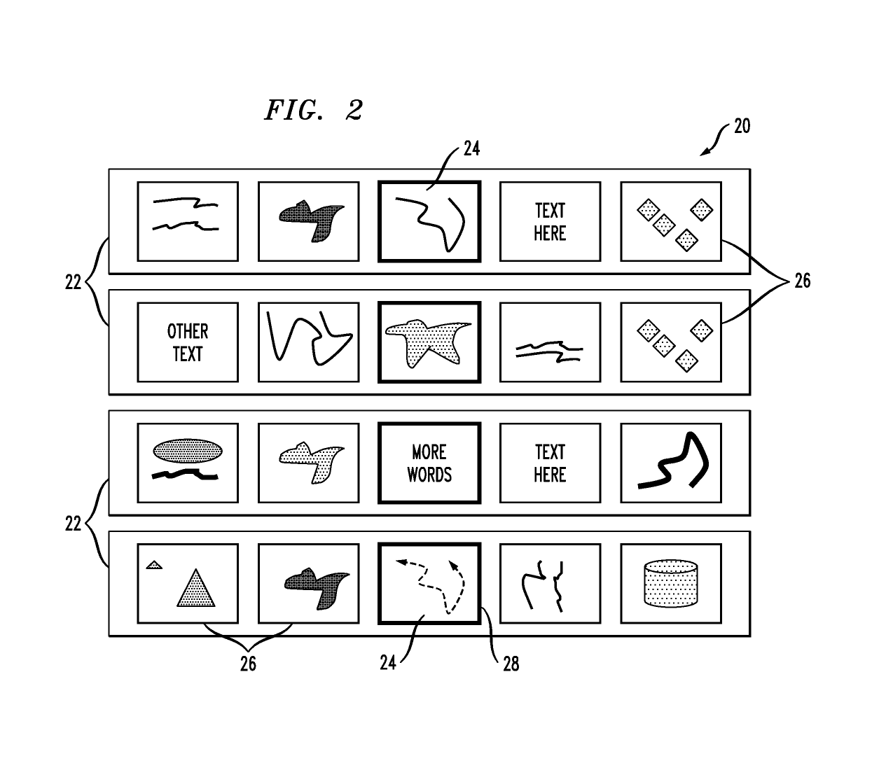

FIG. 2 shows a computer display 20 including exemplary search results generated by the methods provided herein. Each horizontal bar 22 contains information pertaining to a single search result. Search results are typically arranged in order of relevance from top to bottom or from bottom to top. As appreciated by those of skill in the art, many factors influence which results are deemed relevant to a searcher's query and their degree of relevance. Algorithms have been developed and have been used for years for this purpose. Within each horizontal search result bar 22, the image 24 representing the search result appears in the center of the result bar. The center of the result bar may or may not be the center of the display screen itself. To further facilitate the searcher's recognition of this image 24 as the search result, it is distinguished from the other local context images 26 not only by its center position, but also by a distinctive border 28. The border can be a particular color in one exemplary embodiment. Other techniques for distinguishing the image 24 can be alternatively or additionally employed. Additional local context images 26 from the same media object appear to the left and right of each result image 24 in each result bar 22 and provide local context for the search result. Local context images 26 may be, for example, preceding and following slides within a presentation, frames representing preceding and following scenes within a video, or summary pages within a product catalog. In some cases, such as presentations or videos, there is a natural order to the images representing a linear sequence or time ordering. In such cases, the search result image 24 may be adjoined by images of the immediately preceding slides to its left and images of the immediately following slides to the right. In other cases, the order of images may be arbitrary. Images 24, 26 may, for example, comprise text, pictorial content, graphical information or combinations thereof. It will be appreciated that, in some cases, a search result image 24 may have no associated context images 26. In such a case, some result bars 22 may only contain one image 24. In some cases, different numbers of context images 26 may appear in different result bars 22 as there may only be a few images in some digital objects in the searched collection. In the example of FIG. 2, each result image 24 includes two context images 26 to its left and two context images 26 to its right. By displaying at least one and more preferably at least two context images, also known as thumbnail images, on each side of the search result image, if possible, the searcher is more easily able to determine whether he/she has obtained a desired search result. The computer display is preferably also configured as a computer interface that allows the submission of queries and enables the user to select an image, an entire presentation, or other options that may be provided on the display.

For example, in one embodiment each result bar 22 is scrollable to view images that may not be visible on the display screen as originally presented following the search.

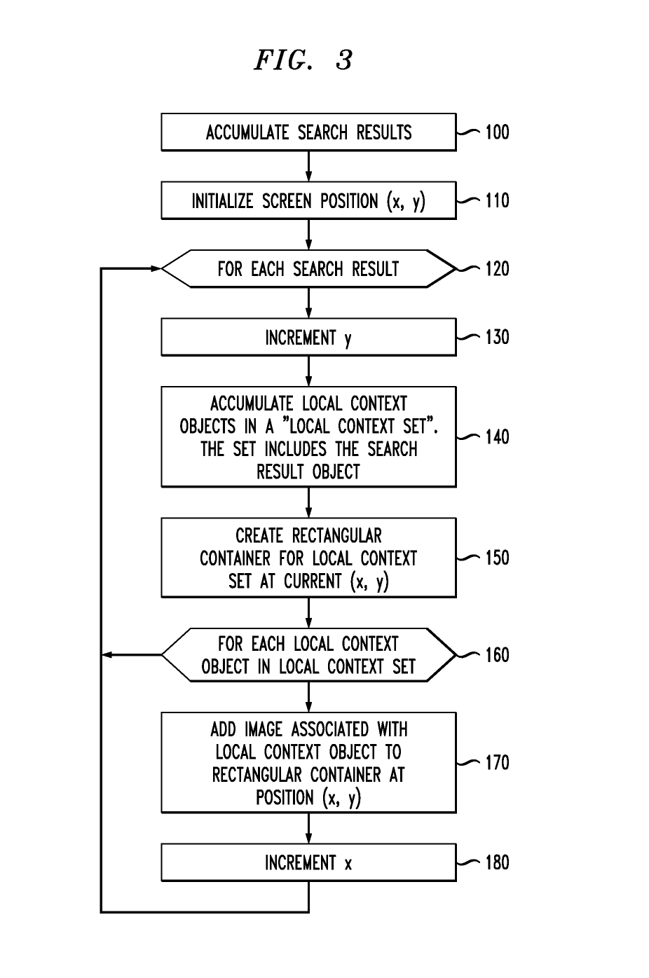

An exemplary method for providing local context for a set of visual media objects returned from a search is illustrated through the flow chart shown in FIG. 3. A set of search images is accumulated in step 100 using any of a variety of access techniques familiar to those of skill in the art. Such techniques may include invoking web-based search services, using a desktop crawler, accessing a database or other techniques for extracting the desired results from stored data. Display screen position variables “x” and “y” are then initialized in step 110. Images within a set of search results are processed individually in step 120. For each result image (corresponding to the exemplary result images 24 shown in FIG. 2), the following steps are performed. The vertical screen position variable “y” is incremented in step 130 using either a fixed offset or an offset based on the size of images within the set of search results. The image being processed in this exemplary embodiment is part of a digital media object that includes a sequence of images. Additional images are extracted from the media object into a local context set in step 140. As shown in FIG. 2, the local context set includes the search result image 24 and additional images 26 if present. For example, if the media object is a slide presentation, the additional images represent one or more slides immediately preceding and one or more slides immediately following the recommended “search result image” slide in an exemplary embodiment. Alternative selection strategies include selecting every nth slide, selecting overview/summary/outline slides, selecting slides with content or title similar to the recommended slide, or all slides from the presentation. Different selection strategies apply to other media types in other exemplary embodiments. For simplicity, the recommended or search result image is also added to the “local context set”. The set accordingly contains all images to be displayed.

A rectangular on-screen container or background, such as a search result bar 22 as shown in FIG. 2, is created for the local context set at the current (x,y) screen position in step 150 in the exemplary method of FIG. 3. The container is large enough to contain all images in the local context set. Step 160 involves the processing of the images in the local context set. Each image is added to the rectangular container at position (x,y) in step 170. The “x” position is then incremented in step 180. The increment accounts for the size of images in the local context set plus any desired horizontal spacing. It will be appreciated that the method produces a set of linear “cartoon strips” which are vertically stacked to permit simultaneous viewing of multiple search results in the context of the digital media objects from which they were obtained, as shown by way of example in FIG. 2. Alternatively, the strips can be oriented vertically with the strips displayed side by side (not shown). Display alternatives for each local context set includes a one-slide-at-a-time slide show or scrolling windows that allow successive views of slide images forward or backward.

The local context sets and images comprising such sets that appear at any one time on the display are preferably limited in number on the screen so that they are of sufficient size to be easily viewed by the user. As discussed above, the search result image is distinguished from the additional context images. While the border is employed to distinguish the search result image 24 in the embodiment of FIG. 2, it could additionally or alternatively be distinguished by being larger in size than the additional images 26. If desired, the additional images 26 could be progressively smaller in display size as distance is increased from the search result image 24.

The computer display 20 as shown in FIG. 2 may be used as an interface by the user in various ways. The horizontal search result bars 22 are provided as panels in an exemplary embodiment that permit scrolling. A query box (not shown) is provided on the display within a separate panel (not shown) in another exemplary embodiment. Upon obtaining search results, the user could select any image in a result bar in order to obtain a substantially full screen view of the image. Scrolling of the images within result bars 22 allows the user to scroll forwards or backwards to view and select images that do not appear on the original display with the search result image. Vertical scrolling to view additional search result bars further facilitates the user's ability to view the search results.

Given the discussion thus far, it will be appreciated that, in general terms, an exemplary method, according to an aspect of the invention, includes the steps of searching a digital object collection comprising a plurality of digital objects having sequences of images and obtaining a plurality of search result images from the sequences of images in the plurality of digital objects. The search result images obtained, respectively, from the digital objects are displayed on a screen of a computer interface in order of relevance. The method further includes displaying local context images in association, respectively, with the search result images, wherein each local context image is obtained from the same digital object as the search result image with which it is associated. By having context images adjoining the search result image from the same work in which the search result image was obtained, the user can more readily determine whether the search has yielded the desired result.

A further exemplary method includes accumulating search result images, such as search result images 24 in FIG. 2, based on a query from a database comprising digital objects having sequences of images. The exemplary method further includes accumulating local context images associated, respectively, with the search result images from the digital objects and forming a plurality of local context sets, each of the local context sets comprising one of the search result images and one or more associated local context images from a same one of the digital objects. FIG. 2 shows such local context sets comprising search result images 24 and local context images 26. A plurality of containers are formed on a display of a computer interface. As discussed above, the containers are rectangular search bars 22 in the embodiment of FIG. 2. The method further includes causing the search result images to be visually distinguished from the local context images and displaying the local context sets within the containers on the computer interface in an order based on relevance to the query. FIG. 2 shows an exemplary display wherein the search result images are visually distinguished from the local context images by having distinctive borders 28.

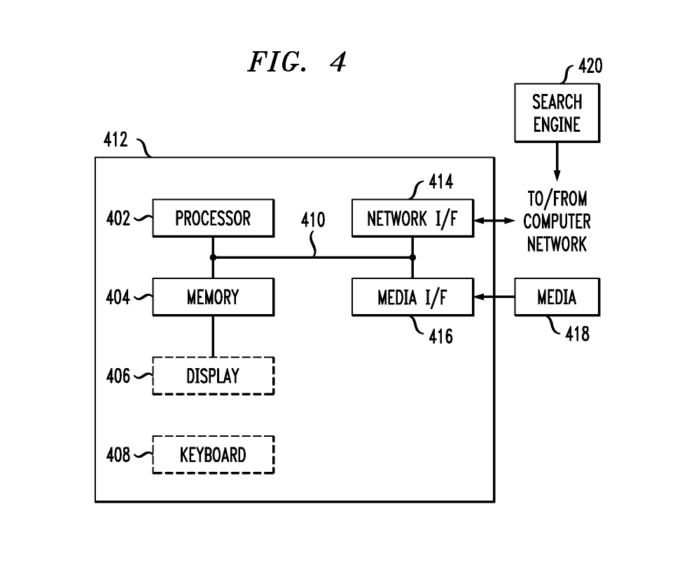

A system disclosed herein includes a memory, a digital object collection comprising a plurality of digital objects having sequences of images, a search engine, a computer interface including a screen, and at least one processor, coupled to the computer interface and memory. The processor is operative to cause the search engine to search the digital object collection in response to a query, obtain a plurality of search result images from the sequences of images in the plurality of digital objects, display the search result images obtained from the digital objects on the screen of the computer interface in order of relevance, and display local context images in association, respectively, with the search result images, wherein each local context image is obtained from the same digital object as the search result image with which it is associated. The processor as shown and described with respect to FIG. 4 is operable to carry out the above steps and, more particularly, the steps described in FIG. 3.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps as discussed above with respect to FIG. 3.

One or more embodiments can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418. As discussed above, the display 20 shown in FIG. 2 can be configured in the same manner as the display 406 in order to function as part of an input/output interface for accessing digitally stored media objects such as slide presentations and videos. A search engine 420 responsive to user queries is employed in some embodiments to find the desired media objects. Search engines are known to those of skill in the art for searching text and images and returning results in order of perceived relevance to a query. Use of one or more search engines would precede step 100 in FIG. 3.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart of FIG. 3 and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a screen position initialization module, a local context object accumulation module, a container creation module, an image addition module and vertical and horizontal incrementing modules. The method steps can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
searching a digital object collection comprising a plurality of digital objects having sequences of images;
obtaining a plurality of search result images from the sequences of images in the plurality of digital objects;
displaying the search result images obtained from the digital objects on a screen of a computer interface in order of relevance;
displaying local context images in association, respectively, with the search result images, wherein each local context image is obtained from the same digital object as the search result image with which it is associated.

2. The method of claim 1, further comprising distinguishing the appearances of the search result images on the screen of the computer interface from the local context images.

3. The method of claim 2, further comprising displaying the search result images in vertical alignment on the screen of the computer interface and displaying the local context images in horizontal alignment with respect to the search result images with which they are associated.

4. The method of claim 3, further comprising centering the search result images and displaying the local context images on the left and right sides of the search result images with which they are associated.

5. The method of claim 4, wherein the local context image on the left side of each search result image is an immediately preceding image in the sequence of images of the digital object from which it was obtained and the local context image on the right side of each search result image is an immediately succeeding image in the sequence of images of the digital object from which it was obtained.

6. The method of claim 4, wherein the local context images include content similar to the search result image which they adjoin.

7. The method of claim 4 wherein the digital objects comprise slide presentations.

8. The method of claim 7, wherein the local context image on the left side of each search result image is an immediately preceding image in the sequence of images of the slide presentation from which it was obtained and the local context image on the right side of each search result image is an immediately succeeding image in the sequence of images of the slide presentation from which it was obtained.

9. The method of claim 1, further including the steps of:
accumulating search result images;
initializing screen position on the computer interface;
for each search result image, incrementing a vertical position on the screen of the computer interface;
creating local context sets, each set comprising one of the search result images and the local context images associated with the one of the search result images;
creating a container on the screen of the computer interface for each local context set;
adding the local context sets to the containers; and
incrementing horizontally on the screen of the computer interface to account for the size of each local context set and spacing between images comprising each local context set.

10. The method of claim 9, wherein the digital objects comprise slide presentations and wherein the local context image on the left side of each search result image is an immediately preceding image in the sequence of images of the slide presentation from which it was obtained and the local context image on the right side of each search result image is an immediately succeeding image in the sequence of images of the slide presentation from which it was obtained.

11. A system comprising:
a memory;
a digital object collection comprising a plurality of digital objects having sequences of images;
a search engine;
a computer interface including a screen;
at least one processor, coupled to the computer interface and memory, and operative to:
cause the search engine to search the digital object collection in response to a query;
obtain a plurality of search result images from the sequences of images in the plurality of digital objects;
display the search result images obtained from the digital objects on the screen of the computer interface in order of relevance;
display local context images in association, respectively, with the search result images, wherein each local context image is obtained from the same digital object as the search result image with which it is associated.

12. The system of claim 11, wherein the processor is further operative to distinguish the appearances of the search result images on the screen of the computer interface from the local context images.

13. The system of claim 12, wherein the processor is further operative to cause displaying of the search result images in vertical alignment on the screen of the computer interface and displaying the local context images in horizontal alignment with respect to the search result images with which they are associated.

14. The system of claim 13, wherein the processor is further operative to center the search result images and display the local context images on the left and right sides of the search result images with which they are associated.

15. The system of claim 14, wherein processor is further operative to position the immediately preceding local context image in the sequence of images of the digital object from which it was obtained on the left side of each search result image and the immediately succeeding local context image in the sequence of images of the digital object from which it was obtained on the right side of each search result image.

16. The system of claim 15 wherein the digital objects comprise slide presentations.

17. The method of claim 16, wherein the local context image on the left side of each search result image is the immediately preceding image in the sequence of images of the slide presentation from which it was obtained and the local context image on the right side of each search result image is the immediately succeeding image in the sequence of images of the slide presentation from which it was obtained.

18. A method comprising:
accumulating search result images based on a query from a database comprising digital objects having sequences of images;
accumulating local context images associated, respectively, with the search result images from the digital objects;
forming a plurality of local context sets, each of the local context sets comprising one of the search result images and one or more associated local context images from a same one of the digital objects;
forming a plurality of containers on a display of a computer interface;
causing the search result images to be visually distinguished from the local context images;
displaying the local context sets within the containers on the computer interface in an order based on relevance to the query.

19. The method of claim 18, further comprising centering the search result images within the containers, causing the containers to be separated vertically from each other on the computer interface, and causing the local context images to be separated from the search result images in a horizontal direction.

20. The method of claim 19, wherein the digital objects comprise slide presentations.
